(19) United States
(12) Patent Application Publication
(10) Pub. No.: US 2008/0028565 A1
(43) Pub. Date: Feb. 7, 2008

(54) Wiper Blade Connecting Element Comprising a Hollow, Open-Topped Housing

(75) Inventor: Jean-Claude Thienard, Gisors (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 10/589,168

(22) PCT Filed: Feb. 9, 2005
(86) PCT No.: PCT/EP05/01276

§ 371 Date: Jun. 5, 2007

(30) Foreign Application Priority Data
Feb. 13, 2004 (FR) 0401496

(51) Int. Cl. B60S 1/40

(52) U.S. Cl. 15/250.201; 15/250.31

(57) ABSTRACT

The invention relates to a coupling element (30) for coupling a windshield wiper blade unit (14), which coupling element defines an upwardly open hollow housing (36) into which a connector (16) is disassemblably received, and comprises two vertical longitudinal side flanges (32) that are interconnected via a transverse rod (34) forming a transverse hinge axis (A), a horizontal bottom wall (50), and two vertical transverse webs, namely a front transverse web (46) and a rear transverse web (48), which webs interconnect respectively the associated front ends and the associated rear ends of the side flanges (32);
the side flanges (32), the transverse webs (46, 48), and the bottom wall (50) defining said upwardly open hollow housing (36) of the coupling element (30);
said coupling element being characterized in that it is provided with at least one channel (54, 56) putting the bottom of the hollow housing (36) into communication with the outside, enabling any liquid present on the top surface (50s) of the bottom wall (50) to be removed.

The invention also relates to a windshield wiper blade unit (14) and to a windshield wiper (10) including such a coupling element (30).

The invention relates to a coupling element for coupling a windshield wiper blade unit of the “flat-blade” type.

More particularly, the invention relates to a coupling element for coupling a windshield wiper blade unit, which coupling element defines an upwardly open hollow housing into which a connector is disassemblably received for assembling to the end of a windshield wiper arm; and which coupling element comprises two longitudinal side flanges that are interconnected via a transverse rod forming a transverse hinge axis about which the connector is hinged, a bottom wall, and two transverse webs, namely a front transverse web and a rear transverse web, which webs interconnect respectively the associated front ends and the associated rear ends of the side flanges; the side flanges, the transverse webs, and the bottom wall defining said upwardly open hollow housing of the coupling element.

It is known that such a coupling element can be used for assembling the wiper blade unit to the front longitudinal end of the arm.

The connector generally fits resiliently over the transverse rod interconnecting the two longitudinal flanges of the coupling element, so as to be able to pivot thereabout, and the front longitudinal end of the arm is curved back longitudinally to form a U-shape in a manner such as to engage between the two sides of the connector, about a central body of complementary shape of the connector.

In a low-height or “low-profile” design for a windshield wiper, the hinged structure of the windshield wiper blade holder that carries the wiper blade proper, i.e. that carries the squeegee or “rubber”, is omitted, and it is, for example, spine members, or structural reinforcement elements analogous to spine members, that are associated with the flexible wiper blade to constitute the wiper blade unit proper, which is then also referred to as a “flat-blade” unit.

The low-height wiper unit is also driven for wiping purposes by a suitable mechanism including a windshield wiper arm, and, in view of the low height of the structural elements, the connector is engaged over the rod of the coupling element which is a separate part mounted on the structure of the wiper unit.

Numerous versions of coupling elements exist, such as, for example, the version described and shown in Document WO-A-00/21811. However, each of those coupling elements can receive only one particular profile of windshield wiper blade unit which is adapted to it.

Thus, when it is desired to assemble a “flat-blade” type windshield wiper blade unit to a conventional vehicle that has a standard windshield wiper arm, such assembly is impossible or at least requires a specific assembly and hinge set, all of whose components are specific.

Document WO-A-03/033316 describes a “flat-blade” type windshield wiper blade unit whose coupling element is suitable for receiving a standard connector, in order to assemble the wiper blade unit to a standard wiper arm.

That coupling element defines an upwardly open hollow housing into which the connector and the end of the arm are received.

Unfortunately that hollow housing also forms a zone in which a quantity of water can accumulate which can then spread progressively onto the windshield of the vehicle after the wiper has wiped it, thereby adversely affecting visibility.

An object of the invention is to propose a coupling element that defines a hollow housing in which no accumulation of water is possible.

To this end, the invention provides a coupling element of the above-described type, characterized in that it is provided with at least one channel putting the bottom of the hollow housing into communication with the outside in the assembled position, enabling any liquid present on the top surface of the bottom wall to be removed.

According to other characteristics of the invention:

said at least one channel consists of an orifice formed through the bottom wall of the coupling element;

the channel is situated longitudinally substantially in register with the transverse rod;

the channel is provided at an interconnection corner at which a side flange is connected to a vertical web of the coupling element;

the channel is defined by a portion of the associated top edge of the side flange and of the front web, in which portion the height of each top edge decreases going towards said interconnection corner, so that the channel substantially forms a V-shaped notch;

the wiper blade unit comprises two aerodynamic elements in the form of longitudinal section member segments of substantially constant vertical cross-section and that are arranged longitudinally in front of and behind the coupling element; and the coupling element is provided with two bottom recesses, each of which is arranged in front of or behind the coupling element, and each of which receives the rear longitudinal end or the front longitudinal end of the rear or of the front aerodynamic element, respectively;

the coupling element is provided with a front protuberance which extends longitudinally forwards from the front transverse web, and with a rear protuberance that extends longitudinally rearwards from the rear transverse web, respectively, and in each of which protuberances a bottom recess is provided;

each bottom recess is of shape complementary to the shape of the longitudinal end of the associated aerodynamic element;

the outside faces of each protuberance are shaped similarly to the outside longitudinal faces of the associated aerodynamic element;

the top edge of the front vertical web is of shape identical to the shape of the front protuberance, so that the top face of the front protuberance is flush with the top edge of the front vertical web;

the connector has two longitudinal cheek plates which are received between the side flanges, and each of which is extended longitudinally forwards by a longitudinal catch for locking the end of the arm in the assembled position in which it is assembled in the connector, and the inside vertical longitudinal face of each flange is provided with a vertical groove that is arranged longitudinally in register with the associated catch of the connector; and

the front vertical edge of the groove is arranged longitudinally behind the free front longitudinal end of the associated catch so that the free front longitudinal end of the catch is in abutment against the inside vertical longitudinal face of the associated flange.

The invention also provides a windshield wiper blade unit including support spine members for supporting a wiper blade, characterized in that it includes a coupling element as defined above and to which the support spine members and the wiper blade are fastened.

The invention also provides a windshield wiper for a motor vehicle, said windshield wiper being characterized in that it includes a windshield wiper blade unit as defined above that is assembled to the front longitudinal end of a windshield wiper arm such that said unit is hinged about the transverse axis, via a hinge and assembly connector that is received disassemblably in the hollow housing of the coupling element.

Other characteristics and advantages of the invention will appear on reading the following detailed description which, in order to make it easier to understand, is given with reference to the accompanying figures, in which:

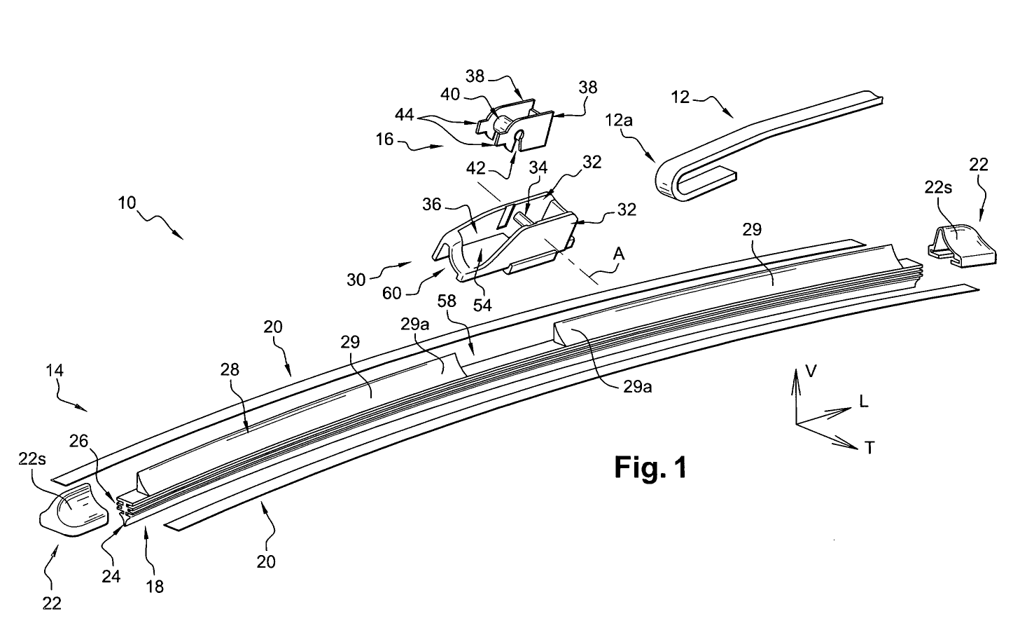

FIG. 1 is an exploded diagrammatic perspective view of a windshield wiper including a coupling element of the invention;

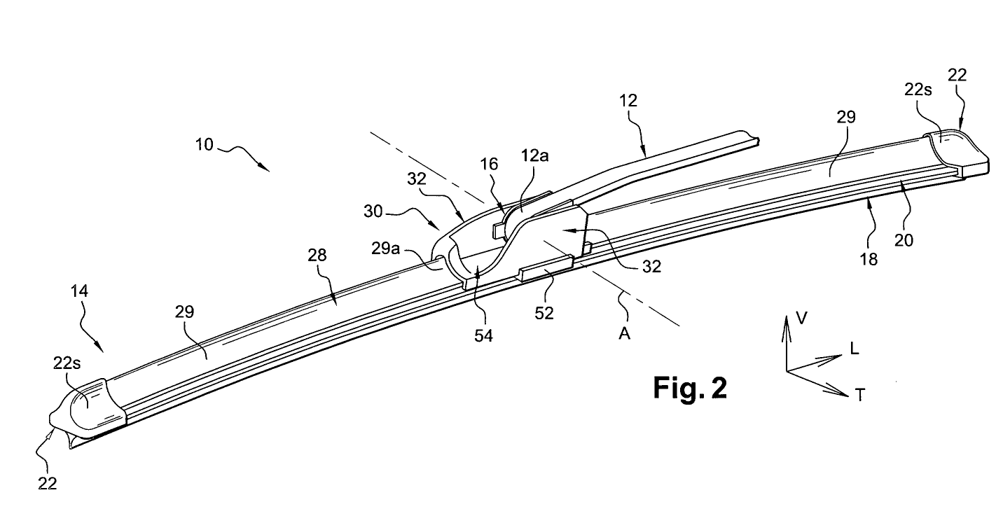

FIG. 2 is a view similar to the FIG. 1 view, in which all of the components of the windshield wiper are assembled;

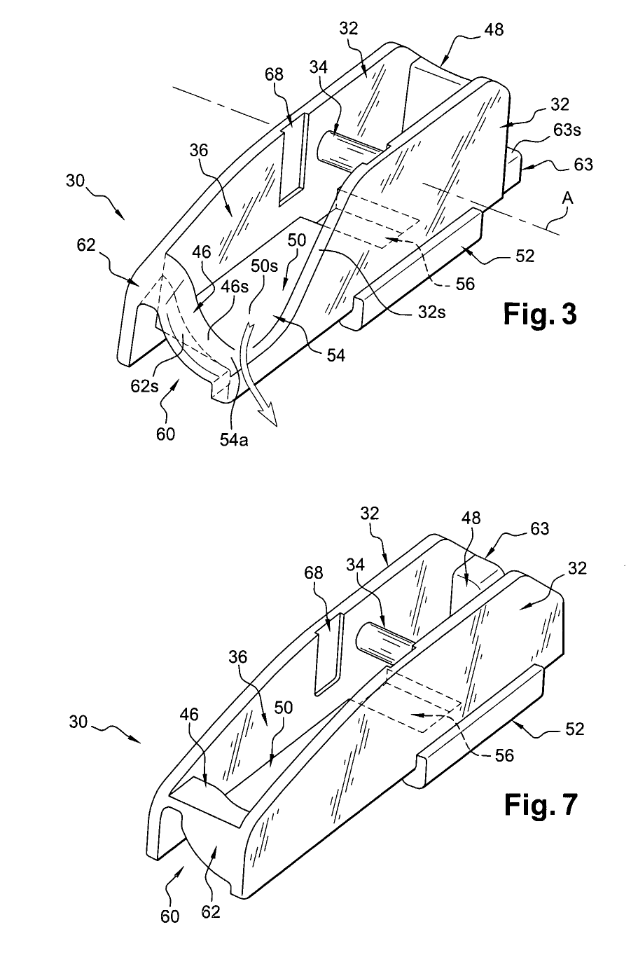

FIG. 3 is a detail view on a larger scale of the coupling element shown in FIG. 1;

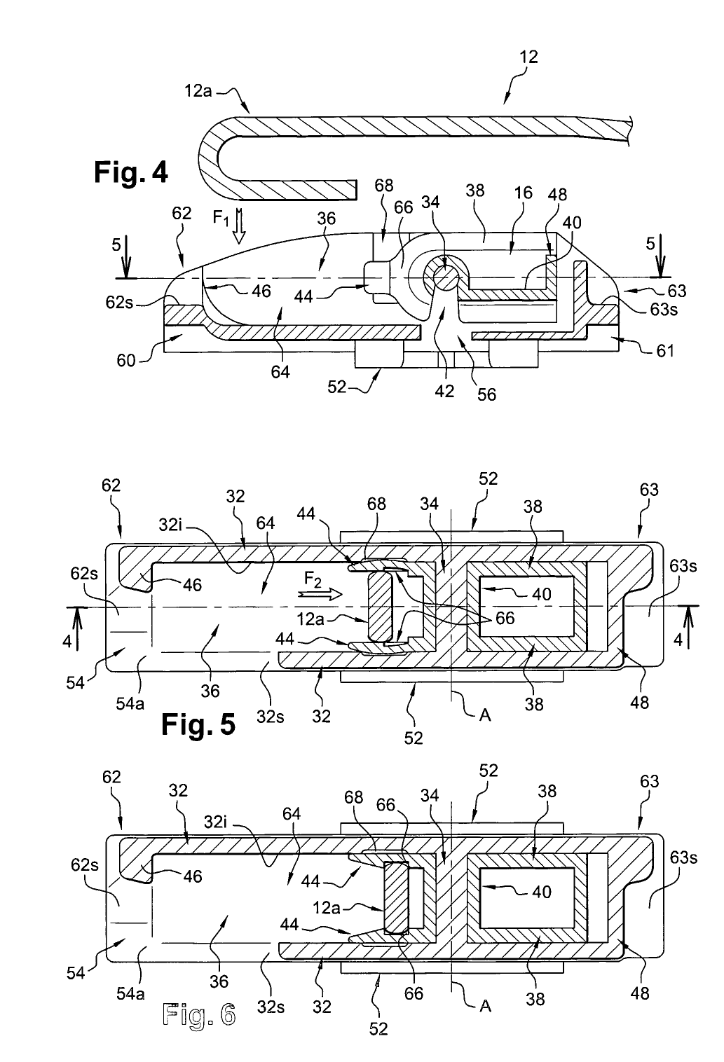

FIG. 4 is a section view on a longitudinal midplane of the windshield wiper shown in FIG. 5, in which the connector is engaged in the hollow housing in the coupling element;

FIG. 5 is a section view on section 5-5 of the windshield wiper shown in FIG. 4, showing the movement of engagement of the arm around the body of the connector;

FIG. 6 is a section view similar to the FIG. 5 view, in which the end of the arm is engaged around the body of the connector; and

FIG. 7 is a view similar to the FIG. 3 view, showing another embodiment of the coupling element.

For the description of the invention, the vertical, longitudinal, and transverse directions are adopted in non-limiting manner as defined in the frame of reference V, L, T indicated in the figures.

The front-to-rear direction is also adopted as being the longitudinal direction from left to right with reference to FIG. 1.

In the description below, elements that are identical, similar, or analogous are designated by like reference numerals.

FIG. 1 shows a windshield wiper 10 which mainly comprises an arm 12, a wiper blade unit 14, and a connector 16 for hinging the wiper blade unit 14 relative to the arm 12, about a transverse axis A.

In this example, the arm 12 consists of a longitudinal rod whose front end 12a is curved back to form a rearwardly open U-shape.

In this example, the wiper blade unit 14 is of the “flat-blade” type, i.e. it is a low-height or “low-profile” windshield wiper blade unit. It is thus made up of a wiper blade proper 18 that extends mainly longitudinally, of two side spine members 20 arranged on either side of the blade 18, and of two end-pieces 22.

The blade 18 is an element made of a flexible material, e.g. rubber, and it comprises a bottom blade proper portion 24 that comes into contact with the windshield of the vehicle (not shown), and an intermediate heel 26.

In order to improve the aerodynamic behavior of the windshield wiper 10 while the vehicle is moving, the blade 18 is provided with a top lip 28 which extends above the heel 26, substantially over the entire length of the blade 18. The top lip 28 is shaped aerodynamically in a manner such that the movement of air generated by the vehicle moving generates a force on the blade that tends to press said blade against the windshield.

The side spine members 20 constitute the support structure of the wiper blade unit 14, and they make it possible to press the blade 18 against the glazing to be wiped, and to drive the blade 18 in a back-and-forth sweeping motion over the glazing.

To this end, the side spine members 20 are metal strips that extend mainly longitudinally, and that are received in complementary grooves provided in the heel 26 of the wiper blade 18, on either side of a vertical longitudinal midplane of the blade 18.

The end-pieces 22 hold the side spine members 20 in position as assembled in the complementary grooves in the blade 18.

For this purpose, as can be seen in FIG. 2, the end-pieces 22 cover the front and rear longitudinal ends of the spine members 20, of the heel 26, and of the lip 28 of the blade 18. The end-pieces 22 are fastened to the heel 26 of the blade 18, or to the spine members 20, in a manner such that they prevent the spine members 20 from moving longitudinally or transversely relative to the blade 18.

Finally, the top portions 22s of the end-pieces 22 are shaped aerodynamically in a manner similarly to the top lip 28.

The wiper blade 14 is further provided with a coupling element 30 which is arranged longitudinally substantially in the middle of the wiper blade unit 14 and which is fastened to the blade 18 and to the spine members 20.

The coupling element 30, which is described in detailed manner below, mainly comprises two side flanges 32 that are interconnected by a transverse rod 34 forming the axis A about which the wiper blade unit 14 is hinged relative to the arm 12. The two flanges 32 define, in part, an upwardly open hollow housing 36, into which the connector 16 is engaged in a downward movement in order to fit over the transverse rod 34.

The connector 16 is a conventional-type connector which has two side cheek plates 38 which are interconnected by a transverse body 40.

The cheek plates 38 and the body 40 define a transverse recess 42 which receives the transverse rod 34 when the connector 16 is engaged in the coupling element 30.

The body 40 of the connector 16 is suitable for being engaged in the U-shaped end 12a of the arm 12, and it is held in the engaged position in which it is engaged in the end 12a of the arm 12 by catches 44 that extend respective ones of the cheek plates 38 longitudinally forwards.

As can be seen in more detail in FIG. 3, the coupling element 30 has the two side flanges 32, each of which extends in a respective vertical longitudinal plane on either side of the coupling element 30.

The coupling element 30 also has a front vertical transverse web 46 that interconnects the front ends of the side flanges 32, a rear vertical transverse web 48 which interconnects the rear ends of the side flanges 32, and a bottom horizontal wall 50.

The side flanges 32, the front and rear webs 46, 48, and the bottom wall 50 define the hollow housing 36.

The coupling element 30 is also provided with hooks 52 which extend the side flanges 32 downwards, and which co-operate with the spine members 20 to fasten the coupling element 30 to the blade 18.

In accordance with the invention, in order to avoid any accumulation of water in the hollow housing 36, the coupling element 30 is provided with a channel 54 that puts the bottom of the hollow housing 36 into communication with the outside, when in the assembled position, thereby making it possible to remove any liquid present on the top face 50s of the bottom wall 50. The channel can be provided in at least the bottom wall 50, the side flanges 32, or the transverse webs 46, 48. The channel enables any liquid present on the top face 50s to be removed immediately to the windshield during wiping of said windshield.

Therefore, one end of the channel 54 opens out onto the top face 50s of the bottom wall 50.

In an embodiment of the invention, the channel 54 is formed at the left front corner of the coupling element 30, i.e. at the connection between the front end of the left side flange 32 and the front vertical web 46.

In this example, the channel 54 consists of a “V-shaped” notch whose bottom 54a, via which the water drains out, is horizontal and is situated in alignment with the top face 50s of the bottom wall 50 of the coupling element 30.

The channel 54 is defined by a portion of the top edge 32s of the left side flange 32 and by a portion of the top edge 46s of the front vertical web.

For this purpose, the top edge 32s of the left side flange 32 and the top edge 46s of the front vertical web 46 are provided with respective sloping portions, the height of sloping portions decreasing going towards the left front corner of the coupling element 30, until the front end or the left end of the top edge 32s, 46s of the left side flange 32 or of the front vertical face 46, respectively, extends at the same height as the top face 50s of the bottom wall 50, at the left front corner of the coupling element 30.

Thus, any water that has accumulated on the top face 50s of the bottom wall 50 can drain out from the coupling element 30, by flowing along the bottom 54a of the channel 54.

In a variant embodiment of the invention, the coupling element 30 is provided with an orifice 56 which is formed through the bottom wall 50, and which itself also puts the hollow housing 36 into communication with the outside, thereby forming a second water-drainage channel.

The coupling element 30 is an integrally molded one-piece part that is molded using two complementary molds, namely a top mold and a bottom mold.

In an implementation of the orifice 56 in the bottom wall 50, said orifice is arranged in register with the rod 34, i.e. the orifice 56 is arranged under the transverse rod 34.

Thus, the orifice 56 enables a bottom portion of the mold to pass through, which bottom portion makes it possible to mold the transverse rod 34.

As can be seen in FIG. 1, the coupling element 30 is fastened to the heel 26 of the blade 18. The top lip 28 is then provided with a central cutout 58 through which the coupling element 30 is assembled to the heel 26.

The top lip 28 is then subdivided into two longitudinal portions 29, which are arranged longitudinally in front of and behind the coupling element 30.

In another aspect of the invention, the coupling element 30 covers the facing ends 29a of the two portions 29 of the lip 28.

This prevents any damage to the associated end 28a of the portion of the top lip 28, in particular caused by a build-up of foreign bodies between the coupling element 30 and each longitudinal portion of the top lip 28.

In addition, it improves the general appearance of the windshield wiper unit 14.

To this end, the coupling element 30 is provided with two end recesses 60, 61 which are arranged in front of and behind the coupling element 30, and each of which is suitable for receiving an associated end 29a of each longitudinal portion 29. Thus, the recess 60 situated in front of the coupling element 30 receives the rear end 29a of the front portion 29 of the top lip 28, and the recess 61 situated behind the coupling element 30 receives the front end 29a of the rear portion 29 of the top lip 28.

The coupling element 30 is provided with a front protuberance 62 which extends longitudinally forwards from the front transverse web 46 and a rear protuberance 63 which extends longitudinally rearwards from the rear transverse web 48, a respective bottom recess 60, 61 being formed in each of said protuberances.

In an implementation of the protuberances 62, 63, their outside shape is similar to the general shape of the top lip 28, and the recesses 60, 61 are of shape complementary to the shape of the associated end 29a of the corresponding portion 29 of the lip 28.

Thus, each protuberance 62, 63 consists of a hollow section-member segment, of longitudinal axis, and whose section on a vertical cross-section follows a profile of substantially constant thickness.

As can be seen in FIG. 3, the front transverse web 46 is shaped in a manner such that the profile of its top edge 46s, and more particularly the sloping portion that defines the channel 54, is identical to the profile of the top face 62s of the front protuberance 62.

In addition, the front protuberance 62 is arranged in a manner such that its top face 62s is flush with the top edge 46s of the front transverse web 46.

Thus, the front protuberance 62 extends longitudinally in alignment with the front transverse web 46, further improving the general appearance of the coupling element 30, and thus of the windshield wiper blade unit 14.

As can be seen in FIGS. 4 to 6, the connector 16 and the arm 12 are assembled in the coupling element 30 firstly by mounting the connector 16 into the hollow housing 36, as shown in FIG. 4, and then by mounting the end 12a of the arm 12 in the hollow housing 36, around the body 40 of the connector 16.

As mentioned above, the connector 16 is mounted in the hollow recess 36 by moving the connector 16 downwards in a manner such as to fit the recess 42 over the transverse rod 34.

The end 12a of the arm 12 is firstly inserted into the hollow housing 36, in a front zone 64 of the hollow housing 36 that is situated in front of the connector 16, as represented by arrow F1.

Then, as shown in FIG. 5, the arm 12 moves longitudinally rearwards, as represented by arrow F2, so as to engage the body 40 of the connector 16 into the end 12a of the arm 12.

In order to lock the connector 16 in the engaged position in which it is engaged in the end 12a of the arm 12, and as mentioned above, the connector 16 is provided with two catches 44 that extend respective ones of the cheek plates 38 of the connector 16 longitudinally forwards.

As can be seen in FIG. 6, the front ends of the catches 44 are ramp-shaped, extending transversely towards the inside of the connector 16, and defining an internal groove 66 in which the front end 12a of the arm 12 is received.

While the end 12a of the arm 12 is being moved rearwards, it is necessary for the catches 44 to be able to move apart in order to allow the end 12a of the arm 12 to pass. Unfortunately, when the connector 16 is in the assembled position in which it is mounted inside the housing 36, the cheek plates 38 and the catches 44 are in abutment against the inside faces 32i of the side flanges 32, which thereby prevent the catches 44 from moving apart.

In order to enable the catches 44 to be moved apart, each flange 32 is provided with a vertical groove 68 which is arranged longitudinally in register with the associated catch 44. Thus, when the body 40 of the connector 16 is engaged in the end 12a of the arm 12, the catches 44 deform elastically in a manner such as to be inserted at least in part into the associated grooves 68.

In implementation of the grooves 68, their respective front vertical edges 68a are arranged longitudinally behind the free front longitudinal end 44a of the associated catch 44.

Thus, when the body 40 of the connector 16 is engaged in the end 12a of the arm 12, as can be seen in FIG. 5, the free front end 44a of the catch 44 remains continuously in abutment against the inside face 32i of the associated side flange 32, and only an intermediate portion of the catch 44 penetrates into the groove 68.

The force necessary for moving the catches 44 apart is thus greater than the force necessary when the free front end 44a is not in abutment against the inside face 32i of the side flange 32, thereby making it possible to guarantee that the end 12a of the arm 12 is held more securely in the engaged position around the body 40 of the connector 16.

FIG. 7 shows another embodiment of the coupling element 30 which is provided with only the orifice 56 for connecting the hollow housing 36 to the outside, i.e. it is not provided with the channel 54.

The two side flanges 32 are then substantially symmetrical relative to each other about a vertical longitudinal midplane of the coupling element 30.

1. A coupling element for coupling a windshield wiper blade unit, which coupling element defines an upwardly open hollow housing into which a connector is disassemblably received for assembling to the end of a windshield wiper arm; and
which coupling element comprises two longitudinal side flanges that are interconnected via a transverse rod forming a transverse hinge axis about which the connector is hinged, a bottom wall, and two transverse webs, namely a front transverse web and a rear transverse web, which webs interconnect respectively the associated front ends and the associated rear ends of the side flanges;
the side flanges, the transverse webs, and the bottom wall defining said upwardly open hollow housing of the coupling element;
said coupling element being characterized in that it is provided with at least one channel putting the bottom of the hollow housing into communication with the outside in the assembled position, enabling any liquid present on the top surface of the bottom wall to be removed.

2. A coupling element according to claim 1, characterized in that said at least one channel consists of an orifice formed through the bottom wall of the coupling element.

3. A coupling element according to the preceding claim, characterized in that the channel is situated longitudinally substantially in register with the transverse rod.

4. A coupling element according to claim 1, characterized in that the channel is provided at an interconnection corner at which a side flange is connected to a vertical web of the coupling element.

5. A coupling element according the preceding claim, characterized in that the channel is defined by a portion of the associated top edge of the side flange and of the front web, in which portion the height of each top edge decreases going towards said interconnection corner, so that the channel substantially forms a V-shaped notch.

6. A coupling element according to claim 1, of the type in which the wiper blade unit comprises two aerodynamic elements in the form of longitudinal section member segments of substantially constant vertical cross-section and that are arranged longitudinally in front of and behind the coupling element;
said coupling element being characterized in that the coupling element is provided with two bottom recesses, each of which is arranged in front of or behind the coupling element, and each of which receives the rear longitudinal end or the front longitudinal end of the rear or of the front aerodynamic element, respectively.

7. A coupling element according to the preceding claim, characterized in that the coupling element is provided with a front protuberance which extends longitudinally forwards from the front transverse web, and with a rear protuberance that extends longitudinally rearwards from the rear transverse web, respectively, and in each of which protuberances a bottom recess is provided.

8. A coupling element according to the preceding claim, characterized in that each bottom recess is of shape complementary to the shape of the longitudinal end of the associated aerodynamic element.

9. A coupling element according to the preceding claim, characterized in that the outside faces of each protuberance are shaped similarly to the outside longitudinal faces of the associated aerodynamic element.

10. A coupling element according to the preceding claim, taken in combination with claim 6, characterized in that the top edge of the front vertical web is of shape identical to the shape of the front protuberance, so that the top face of the front protuberance is flush with the top edge of the front vertical web.

11. A coupling element according to claim 1, of the type in which the connector has two longitudinal cheek plates which are received between the side flanges, and each of which is extended longitudinally forwards by a longitudinal catch for locking the end of the arm in the assembled position in which it is assembled in the connector;
said coupling element being characterized in that the inside vertical longitudinal face of each flange is provided with a vertical groove that is arranged longitudinally in register with the associated catch of the connector.

12. A coupling element according to the preceding claim, characterized in that the front vertical edge of the groove is arranged longitudinally behind the free front longitudinal end of the associated catch so that the free front longitudinal end of the catch is in abutment against the inside vertical longitudinal face of the associated flange.

13. A windshield wiper blade unit including support spine members for supporting a wiper blade, characterized in that it includes a coupling element according to claim 1 and to which the support spine members and the wiper blade are fastened.

14. A windshield wiper for a motor vehicle, said windshield wiper being characterized in that it includes a windshield wiper blade unit according to the preceding claim that is assembled to the front longitudinal end of a windshield wiper arm such that said unit is hinged about the transverse axis, via a hinge and assembly connector that is received disassemblably in the hollow housing of the coupling element.

15. A coupling element according to claim 2, characterized in that the channel is provided at an interconnection corner at which a side flange is connected to a vertical web of the coupling element.

16. A coupling element according to claim 3, characterized in that the channel is provided at an interconnection corner at which a side flange is connected to a vertical web of the coupling element.
